(19) United States
(12) Patent Application Publication
(10) Pub. No.: US 2026/0004232 A1
(43) Pub. Date: Jan. 1, 2026

(54) METHODS AND SYSTEM FOR ADJUSTING AVAILABLE INVENTORIES AND FOR ALLOCATION OF ORDERS BASED ON PREDICTED ITEM UNAVAILABILITY

(71) Applicant: Target Brands, Inc., Minneapolis, MN (US)

(72) Inventors: Sneha DESHPANDE, Bengaluru (IN); Atul GOEL, Bengaluru (IN); Ganesh BHAT, Bengaluru (IN); Kowshik TALLAM, Bengaluru (IN); Omkar PATIL, Bengaluru (IN); Pramod MULKI, Bengaluru (IN); Pratik CHAUDHARI, Bengaluru (IN); Sohini MITRA, Bengaluru (IN); Sultan AHMED, Bengaluru (IN); Vinay PATIL, Bengaluru (IN); Yogesh HD, Bengaluru (IN)

(21) Appl. No.: 19/189,934

(22) Filed: Apr. 25, 2025

Related U.S. Application Data
(60) Provisional application No. 63/664,588, filed on Jun. 26, 2024.

(51) Int. Cl. G06Q 10/087; G06F 18/2415; G06Q 30/0201

(52) U.S. Cl. CPC G06Q 10/087; G06F 18/2415; G06Q 30/0206

(57) ABSTRACT

Disclosed herein are systems and methods for predicting the probability of an inventory-not-found occurrence during fulfillment of an order, and for utilizing that predicted probability to improve order allocation applications and inventory systems. The disclosed systems and methods utilize machine learning predictive models to determine and score fulfillment performance of individual nodes by predicting their likelihood of an inventory-not-found event. At least some data received at the machine learning predictive application may be realtime data to reflect current conditions. In some examples, some data received at the machine learning application may be pre-computed data. The machine learning models generated by training at the machine learning application may include individual models used for different item categories. In some examples, a threshold suppression amount is utilized to adjust an amount of available inventory utilized to provide item availability (i.e. availability to place an order online) to a customer.

### CROSS-REFERENCE TO RELATED APPLICATION(S)

This application claims the benefit of U.S. Provisional Patent Application No. 63/664,588, filed Jun. 26, 2024, which is incorporated by reference herein in its entirety.

### BACKGROUND

An enterprise that provides avenues for customers to remotely order items (for example, online ordering) for pick-up or delivery may allocate the orders to one or more nodes for fulfillment (i.e. packing and shipping). An order allocation application may apply allocation logic to select a particular node from which to ship, including analysis of inventory levels. Nodes may be a store or may be a warehouse within the enterprise supply chain. However, individual nodes may not have an item of an allocated order in stock despite inventory levels indicating that the item is available. This can result in an “inventory not found” (INF) event, which may result in split orders, order delays, order reallocation (so that the item is obtained from other nodes), or order cancellation. This causes a negative guest experience and underutilization of capacity at high quality nodes. Further, inventory systems and order allocation applications rely on accurate inventory availability data in order to efficiently perform their functions. Current systems lack ability to generate efficient inventory availability data based on realtime information and when confronted with a large number of data messages to ingest. Inaccurate inventory may have many causes, including inventory discrepancies, walk-in/floor sales, customer try-on, item misplacement, order fulfillment time constraints, and others. Systems to more accurately identify nodes for shipment/fulfillment and to reduce an amount of suppression stock that is required to maintain low INF rates at a number of nodes may be beneficial.

### SUMMARY

In general, the subject matter of this disclosure relates to an improvement in systems that utilize machine learning models to determine and score fulfillment performance of individual nodes by predicting their likelihood of an INF event. Individual machine learning models may be trained and for different item categories as defined by the enterprise. The machine learning models may use realtime prediction to improve accuracy (rather than periodic prediction), and may receive input data from an inventory available to promise (ATP) application. By processing the received data messages from ATP in realtime, the INF prediction becomes significantly more accurate. In examples, a predictive machine learning model is developed to determine likelihood of an INF event. In example implementations, historical order fulfillment data may be collected, including orders that are fulfilled successfully as well as orders that incur INF events. Such historical data may be segmented into a plurality of segments. Each segment may then be analyzed and modeled. A set of features is obtained associated with each segment that is modeled, and particular features that demonstrate differences between the segments are identified. Models are then developed, and may account for both recency and seasonality. The INF prediction may be utilized to more accurately identify nodes for fulfillment and to reduce suppression stock amounts required to maintain low INF rates.

Accordingly, the present application describes a computing system, comprising: at least one processor; and at least one memory storing computer-executable instructions for generating inventory-not found probability predictions for a plurality of item-node pairs, the computer-executable instructions when executed by the at least one processor causing the computer to: receive item data relating to each of a plurality of items, wherein the item data comprises an item category; receive node data relating to each of a plurality of nodes; for each item-node pair, wherein an item-node pair corresponds to a particular item of the plurality of items that is intended to be inventoried at a particular node of the plurality of nodes: select, based at least on the item category of the item of the item-node pair, at a machine learning application, a machine learning model of a plurality of machine learning models to update; receive, at the machine learning application, training input data, the training input data received being based at least on the item category, the training input data comprising: historic inventory-not-found rates for one or more timeframes at the node of the item-node pair; historic inventory-not-found rates for one or more timeframes for the item of the item-node pair at the node of the item-node pair; inventory-not-found rates for a department class associated with the category of the item of the item-node pair; and real-time inventory level data for the node of the item-node pair; wherein at least a first subset of the training data inputs is real-time data, wherein at least a second subset of the training data inputs is pre-computed feature data; based on the item category, assigning a weight to each of the training data inputs; using the weighted training data inputs, re-train the machine learning application to generate an updated version of the selected machine learning model; receive model data inputs at the updated machine learning model; and predict, at the updated machine learning model, an inventory-not-found probability for the item of the item-node pair at the node of the item-node pair.

In examples, the described computing system further comprises instructions to: receive, at the machine learning application, historical order fulfillment data associated with a plurality of item-node pairs, the historical order fulfillment data comprising historical inventory not found data, historical inventory data, store attribute data, and item attribute data; segmenting the historical order fulfillment data into a plurality of segments; determining a set of features from the historical order fulfillment data; performing a feature selection process to select features in each of a plurality of classes of item data, the selected features being indicative of differences between the plurality of classes; fine-tuning hyperparameters utilized to configure a predictive classification model; and save the predictive classification model as one of the plurality of machine learning models.

The present application also describes a method comprising: receiving historical order fulfillment data associated with a retail enterprise, the historical order fulfillment data including historical inventory not found data, historical inventory data, store attribute data, and item attribute data; segmenting the historical order fulfillment data into a plurality of segments; determining a set of features from the historical order fulfillment data; performing a feature selection process to select features in each of a plurality of classes of item data, the selected features being indicative of differences between the plurality of classes; fine-tuning hyperparameters utilized to configure a predictive classification model; based on providing subsequent order information to the predictive classification model, generating a generating a predicted inventory-not-found probability at a node associated with the retail enterprise; determining that the predicted inventory-not-found probability exceeds a cutoff inventory-not-found probability; determining a threshold inventory suppression value that is less than a predetermined threshold inventory suppression cap; transmitting the determined threshold inventory suppression value to an available-to-promise application; and at the available-to-promise application, adjusting an inventory available value based on the determined threshold inventory suppression value, causing the adjusted inventory available value to be displayed on a user interface of a customer.

The present application also describes a method comprising: receiving historical order fulfillment data associated with a retail enterprise, the retail enterprise comprising one or more nodes, the historical order fulfillment data including historical inventory-not-found data, historical inventory data, store attribute data, and item attribute data; segmenting the historical order fulfillment data into a plurality of segments; determining a set of features from the historical order fulfillment data; performing a feature selection process to select features in each of a plurality of classes of item data, the selected features being indicative of differences between the plurality of classes; fine-tuning hyperparameters utilized to configure a predictive classification model; receiving an order for at least one item from a customer, the at least one item corresponding to an item-node pair; based on providing order information associated with the received order to the predictive classification model, generating a predicted inventory-not-found probability at a node of the one or more nodes that is associated with the item-node pair; converting the predicted inventory-not-found probability into a cost value; receiving, at an order allocation application, the cost value; and based at least in part on the cost value, allocating the ordered at least one item to the node associated with the item-node pair.

The present application also describes a method of predicting an inventory not found event occurring in a retail enterprise in response to receipt of a digital order, the method comprising: receiving historical order fulfillment data associated with the retail enterprise, the historical order fulfillment data including historical inventory not found data, historical inventory data, store attribute data, and item attribute data; segmenting the historical order fulfillment data into a plurality of segments; determining a set of features from the historical order fulfillment data; performing a feature selection process to select features in each of a plurality of classes of item data, the selected features being indicative of differences between the plurality of classes; fine-tuning hyperparameters utilized to configure a predictive classification model; and based on providing subsequent order information to the predictive classification model, generating a prediction of likelihood of an inventory not found event at a node associated with the retail enterprise.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system wherein orders are placed, allocated to various nodes, and inventory availability is predicted, according to an example.

FIG. 2 illustrates an example system for predicting inventory-not-found probability, and for adjusting available inventories and allocation of orders, according to an example.

FIG. 3 illustrates example operations for training an inventory-not-found probability model, according to an example.

FIG. 4 illustrates an example method for predicting inventory-not-found probability, according to an example.

FIG. 5 illustrates example features utilized in the machine learning models of the disclosed systems and methods, according to an example.

FIG. 6 illustrates example operations for predicting inventory-not-found probability for selected example items, according to an example.

FIG. 7A illustrates example class imbalance and class overlap diagrams, according to an example.

FIG. 7B illustrates an example percentage of samples per class, showing an among of class imbalance, according to an example.

FIG. 7C illustrates an example amount of class overlap, according to an example.

FIG. 7D illustrates an example table including class imbalance data by data segment, according to an example.

FIG. 7E illustrates a reduced example amount of class overlap, according to an example.

FIG. 8A illustrates an example chart depicting an improvement in recall data, according to an example.

FIG. 8B illustrates an example chart depicting an improvement in precision of INF predictions, according to an example.

FIG. 9 illustrates an example user interface depicting an inventory availability before and after a threshold adjustment, according to an example.

FIG. 10 illustrates an example method for adjusting an available inventory level, according to an example.

FIG. 11 illustrates example inventory-not-found probability cutoff values for use in the disclosed systems and methods, according to an example.

FIG. 12 illustrates a depiction of online orders being allocated to a particular node for fulfillment, according to an example.

FIG. 13 illustrates an example method for allocation of orders for fulfillment that takes into consideration a predicted inventory-not-found probability, according to an example.

FIG. 14 illustrates example predicted inventory-not-found probability data and order allocation system costs for an order including multiple items, according to an example.

FIG. 15 illustrates an example block diagram of a computing system.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Disclosed herein are systems and methods for predicting the probability of an INF occurrence during fulfillment of an order, and for utilizing that predicted probability to improve order allocation applications and inventory systems. When customers place orders for one or more items, an order allocation application allocates the order items to one or more fulfillment locations/nodes (for example, stores or warehouses). In examples where an order includes more than one item, the entire order (for example, all items) may be allocated to a single node, or partial orders (each including one or more items of the order) may be allocated to different nodes. These allocated orders (whether entire or partial) are released to their respective allocated nodes so that they can be picked and packed for delivery to the customer or pick-up from the node by the customer or a last-mile carrier. Problems can arise if individual nodes do not have an item of an allocated order in stock despite inventory levels indicating that the item is available, resulting in an “inventory not found” (INF) event. In some examples, a threshold suppression amount is utilized to adjust an amount of available inventory utilized to provide item availability (i.e. availability to place an order online) to a customer. For example, if an inventory system (for example, such as an available to promise system) indicates originally that 7 of a particular item are available at a specified node, an applied threshold suppression amount of 2 will decrease the available to promise amount of that item at that node to 5.

The disclosed systems and methods utilize machine learning predictive models to determine and score fulfillment performance of individual nodes by predicting their likelihood of an INF event. In some examples, disclosed methods of predicting INF events includes analysis of historical INF data, inventory data, and store and item attribute data. At least some data received at the machine learning predictive application may be realtime data to reflect current conditions. In some examples, some data received at the machine learning application may be pre-computed data. The machine learning models generated by training at the machine learning application may include individual models used for different item categories, for example: Apparel/Accessories, Hardlines, Home, Essentials/Beauty, Food/Beverage, and/or other item categories defined by the enterprise.

In example, the input data to the machine learning application is segmented in a preprocessing/segmentation stage into a plurality of segments using, for example predetermined business rules/segmentation rules. The segmentation of the data creates a plurality of data segments, each of which has reduced class imbalance relative to the overall data set. In examples, when such business rules are utilized, the properties of the data segments (for example, data proportion, INF rate, and/or others) may repeat across time periods (for example, months, days, or another appropriate time period), thus indicating consistent patterns. These patterns may contribute to model learning (e.g. training and/or retraining) and model predicting stability/accuracy on unseen data.

Class imbalance occurs when a data set is heavily skewed toward one class, e.g., a majority class, with very few samples representing a minority class. Class imbalance might otherwise result in bias toward learning patterns from the majority class at the expense of learning patterns from the minority class. Additionally, the segmentation data results in data segments having less class overlap. Class overlap refers to instances of multiple classes sharing a common region in the data space. Such class overlap makes the classification process more challenging, because there are less distinct boundaries between the two classes. The combination of class imbalance and class overlap historically has resulted in exacerbation of accuracy challenges, especially for a minority class of the data. The described methods and systems result in improved predictions that overcome (or reduce) class imbalance and class overlap effects.

Each of the segments is analyzed and feature engineering is performed, including handling of missing values, deriving new features, and treatment of outliers. This process reduces overall class overlap within the data in each of the segments. A feature finalization process may then be performed to select features that demonstrate salient differences between the classes. Once a set of features is selected, hyper parameters are fine tuned to improve model output. This results in a trained, fine tuned model usable for predicting INF events.

Once a fully trained model is provided, a modeling approach may make use of one or both of two types of data to perform a modeling process or predicting process. The data may include recency data to capture recent patterns in INF events, as well as seasonality data, to capture patterns in INF events during the same time in a preceding year. This enables the underlying model (e.g., a tree-based boosting classification algorithm) to be aware of both current and event specific data.

In examples, data drift may be analyzed, and models may be retrained on a periodic, automatic, or as needed basis with new sets of recent and seasonal patterns to maintain model performance. In examples, a change in data segment properties (for examples, data proportion, INF rate, and/or others), due to events/promotions during a time period (for example, a season or year) may be indicative of data drift.

In some examples, the machine learning predictive models generate predictions in realtime to improve accuracy (rather than generating predictions periodically, such as daily). Inputs to the models may include data messages from the ATP application, which keeps track of current on-hand and available quantities of items at each node. By processing the messages from ATP in realtime (for example, automatically triggered running and/or retraining of the model, utilizing realtime input data), the INF prediction becomes significantly more accurate. The inputs may be weighted or prioritized based on the item category associated with a particular machine learning model.

The INF prediction may be utilized to both: more accurately identify/allocate nodes for order fulfillment/shipment; and reduce suppression stock (i.e. decrease a threshold suppression factor) that is required to maintain low INF rates. For example, for those nodes that have low predicted INF probabilities, a reduction of suppression stock may be determined advisable, and can be used to update ATP levels. This increases the number of items available for online orders during a timeframe and can potentially have other downstream effects on the enterprise's supply chain (e.g., increasing sales from the node, resulting in higher stocking levels, improved sales performance metrics, and the like).

In another example, for those nodes that have high predicted INF probabilities, an order allocation application may allocate fewer orders to that particular node during a timeframe. This increases the probability that an order will be fulfilled without an INF event, leading to improved customer satisfaction and preventing reallocation (and therefore reducing shipping expense resulting from allocation to a less ideal node as well as reducing extra computing system processing required to handle the reallocation operations), order cancellation, fulfillment delays, and/or splitting of orders.

Further benefits include an overall increase in physical inventory availability, an increase in item/order consolidation, a decrease in expenses associated with consolidation/fulfillment and shipping, and improved consolidation and allocation over a plurality of nodes (for example, more efficiently utilizing under-utilized high-performing nodes while not overwhelming low-performing nodes).

The systems themselves will be improved by at least selecting some inputs to pre-compute periodically for use in training and running in realtime the machine learning models. Utilizing the machine learning models in realtime (and using at least some realtime data in the models) improves the accuracy of the INF predictions, and therefore efficiency of downstream systems that utilize the predictions. The methods and systems disclosed herein have been proven to be successful in enhancing precision and recall of the generated predictive models, resulting in a remarkable decrease of 4% in the INF rate and a decrease of approximately 3.7% in the average of surplus packages. Selecting to pre-compute some inputs decreases the computing power that is required to provide the realtime predictions as well as the time necessary to compute the predictions (freeing up the systems to perform other computing tasks).

Further, in some examples, when the realtime predictions result in a change in a probability score for an item-location combination, if the change is below a certain threshold, the threshold suppression factors may not be updated or the order allocation application may not utilize the updated scores. In such examples, the disclosed methods reduce the number of messages, computations, and communications between the related computer system applications and components by an order of magnitude. In some examples, the applications and platforms receiving information/data from the disclosed INF prediction platform may be technologically limited as to how much data they can receive over a time period. Disclosed systems may monitor data and requests sent, to moderate the amount of system communications and traffic that is communicated, so as to not overload other systems. For example, improvements as described above, requests and/or information may only be sent if a predicted INF factor is greater than a threshold factor. In some examples, data and/or requests may only be sent (or may be sent at a higher frequency) during certain timeframes when the other applications or platforms are not expected to see high traffic (for example, only during a certain part of the day considered to be non-peak hours).

The use of data segmentation in the disclosed systems and methods to simultaneously handle both class imbalance and overlap utilizes an approach that emphasizes segmenting data based on business rules, such that properties of the segments repeat over time. This ensures consistent INF patterns for machine learning (e.g. training and/or retraining) and stability/accuracy of model prediction on unseen data. Further, the disclosed segmentation approach ensures that the data distribution is not changed, so that the model training and testing environments remain similar. This is in contrast to different ways of currently-known under sampling and oversampling techniques that cause changes in data distribution between training and testing data sets, and such currently-known approaches fail when both imbalance and overlap are present in the data.

In examples, due to the potential presence of both imbalance and overlap, clustering currently-known algorithms have difficulty find the current data segments. In such currently-known systems, clustering may generate one large cluster (for example, with more than 90% of the data) and several noisy small clusters. Alternatively (and beneficially), the segmentation approach of the disclosed systems and methods creates useful subgroups (e.g. instead of clustering) that are more meaningful and that have consistent patterns that are advantageous for model learning.

Previous systems only generated predicted INF event probabilities once a day or less, based on historical data, and utilized other machine learning algorithms (such as random forest classifiers). The current system may generate predicted INF probabilities much more frequently, and may do so using realtime inventory data. In the examples disclosed herein, the system comprises a tree-based (gradient-boosting) machine learning algorithm, which has advantages over previous systems, including increased speed and accuracy of generating INF prediction probabilities when training models based on realtime input data.

The disclosed systems have improved scalability and capacity over previous systems. The predictive models as generated by the disclosed systems and are able to perform up to at least around 1.8 billion INF predictions per day by incorporating changes in inventory in real-time, for in-stock items at a store.

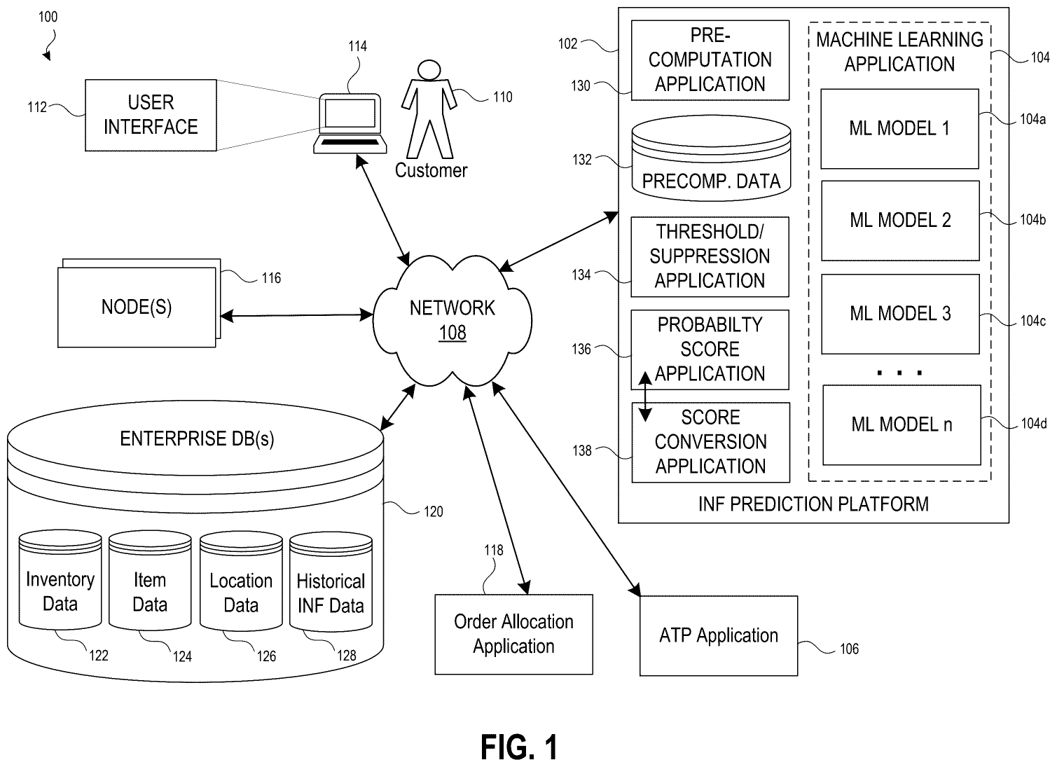

These and other examples will be explained in more detail below with respect to FIG. 1-FIG. 15.

FIG. 1 illustrates an example system 100 wherein orders are placed, allocated to various nodes 116, and inventory availability for item-node combinations is predicted. In some examples, the devices, applications, and systems of system 100 are configured to send and receive data via network 108. In some examples, as described herein, network 108 may include a computer network, an enterprise intranet, the Internet, a LAN, a Wide Area Network (WAN), wireless transmission mediums, wired transmission mediums, other networks, and combinations thereof. Although network 108 is shown as a single network in FIG. 1, this is shown as an example and the various communications described herein may occur over the same network or a number of different networks.

In some examples, a customer user 110 may place a virtual order at a user interface 112 (for example, an online shopping interface including a virtual shopping cart) via a device 114. In an example, user interface 112 is a web application. In other examples, user interface 112 is a device application. User interface 112 may be presented to the customer user 110 via a display of device 114. In some examples, device 114 may be a desktop computer, a laptop computer, a tablet, a cell phone, a smart TV, a smart wearable device, or other appropriate electronic device which is capable of displaying and facilitating interaction with the user interface 112.

When the customer user 110 is viewing an item or searching for an item, user interface 112 may be dependent on an inventory quantity as provided by available to promise (ATP) application 106. ATP application 106 monitors and/or stores current available inventory quantities of items. The available inventory item quantities change dynamically due to sales (for example, in store or online sales of items) and replenishment or restock of items. ATP application 106, in some examples, sends many messages per second (for example, around 2000 messages per second) to other systems for processing. These messages are processed, in part, to provide inventory drift information to the enterprise. This inventory drift information derived from the ATP application 106 inventory data influences INF events heavily. For example, an increase in inventory (for example, due to replenishment of stock) at a node location may mean that that node location has a lesser probability of an INF event. In contrast, when an item is sold, an inventory at the relevant node is depleted and these lower inventory levels can lead to an INF event. The dynamic real-time data from ATP application 106 may be used at machine learning application 104 as inputs. INF prediction platform 102 is configured to run multiple threads to read and process the many dynamic real time messages from the ATP application 106. Part of this processing includes inferring which item category the item belongs to so that the data can be applied to the appropriate corresponding machine learning model as discussed below.

In an example, when searching for an item, if the ATP application indicates that the item is out of stock at a particular node or a plurality of nodes, the user interface 112 may not include the item in the search results or may indicate that the item is unavailable. In an example, when viewing an item, if the ATP application indicates that the item is out of stock at a particular node or a plurality of nodes, the user interface 112 may indicate that the item is unavailable. In another example, when viewing an item, the user interface 112 may indicate how many of the item are available at a particular node. In yet another example, the user interface 112 may provide the customer user 110 with additional options based on the inventory quantity of an item. For example, two of a particular item may be available for pickup from one node, none of an item may be available for same-day delivery from another node, and the item may be available for ship-to-home delivery from at least a third node.

Data relating to the virtual order may be received at an order allocation application 118. Order data may include a quantity of items, product/item information (for example, including product identification information/a product identifier, size, features, categories, pricing, vendor/supplier, storage and/or shipping considerations, and/or other information related to items sold/provided by the enterprise), a shipping destination, and/or a shipping/delivery deadline. Order allocation application 118 may allocate the item(s) (as a whole order or as multiple partial orders) to nodes 116 for processing/fulfillment. Order allocation application 118 may also receive information from an inventory not found (INF) prediction platform 102 as described herein, and may also receive information from other sources internal to or external to the enterprise (for example, data that has been stored in an enterprise database(s) 120), including node location information, carrier information, item stock information (for example, information from ATP application 106), facility staffing information, and other data. Methods and system for order allocation are further described in U.S. Pat. No. 11,514,395, entitled, “System for cost efficient order fulfillment,” which is incorporated herein in its entirety by reference, except for any inconsistencies.

Orders are allocated to one or more nodes 116. A node 116 may be a store, warehouse, distribution center, production facility, or other enterprise facility with the capacity to store inventory items, pick the items, and pack the items for carrier and/or customer pickup.

An INF prediction platform 102 receives realtime data associated with items offered for purchase by the enterprise, nodes, orders, and historical INF data. In some examples, the data is received from an order allocation application 118, ATP application 106, node(s) 116, and/or various enterprise databases 120. INF prediction platform selects certain received data to be utilized to compute pre-computed data at pre-computation application. Pre-computed data may include, in particular examples, data/features such as: items/units sold in a time period (for example, a month, season, week, etc.), average inventory on-hand at a location in a las n number of days, ratio of total INF to total shipping requests at a location in a last n number of days, a quantity of an item on the salesfloor of a location, a retail price of an item at a location on a specified date, and/or other data metrics. Pre-computed data may be updated periodically or in response to a triggering event or data receipt. Pre-computed data may be stored in a pre-computed data database 132. In some examples, pre-computed data database 132 is associated with INF prediction platform 102; in other examples, pre-computed data database 132 is associated with other databases or storage, such as enterprise database(s) 120.

In some examples, the probability of INF is pre-computed. In such an example, when there is change in a feature (in some examples, data features may be measured once a day and inventory may be monitored in near-realtime) that can influence the probability of INF, probability calculation is triggered, and probability is computed and stored in a cache. Then, when GOA needs to be allocated, data can be extracted for the required item locations for requested demand and the algorithm may be run efficiently.

A machine learning application 104 receives realtime data, pre-computed data, historical order fulfillment data, and/or historical INF data (for example, from one or more of enterprise databases 120) and utilizes the data to train and re-train one or more machine learning models 104a-104d. In examples, the machine learning application 104 performs such training/retraining in realtime. In some examples, the machine learning application 104 performs such training/retraining periodically (for example, weekly, monthly, daily, quarterly, semiannually, biannually, annually, seasonally, or another appropriate period). In some examples, the machine learning application 104 performs such training/retraining in response to a trigger or detection/occurrence of an event.

In some examples, a set of machine learning models 104a-104d are generated that correspond to different categories of items, or other aligning item characteristics. The machine learning model(s) 104/104a-104d generate predicted probabilities that a certain item-node combination will experience an INF event (i.e. the probability that a particular item will be not found when an inventory level states that it should be found at a particular node when an order for the item is allocated to the node). In some examples, INF probabilities are predicted for each item-node combination/pair for each item at a node where inventory data indicates that the item is intended to be stocked or has been stocked. In some examples, the INF prediction platform predicts INF probabilities for at least 200 million item-node pairs. Each machine learning model is associated with a category of items available for purchase by the enterprise. For example, ML model 1 104a may be trained to predict INF probabilities for item-node combinations/pairs including items of a women's clothing/accessories category; ML model 2 104b may be trained to predict INF probabilities for item-node pairs including items of a men's clothing/kids clothing category; ML model 3 104c may be trained to predict INF probabilities for item-node pairs including items of a food/beverage category; and a plurality of other ML models n 104d may be trained to predict INF probabilities for item-node pairs including items of other categories. In examples, the ML models 104a-104d may be built on an item class/classification/category level. In some examples, other categories may include hardlines, essential items, home items, beauty/cosmetics, promotional items, tools, outdoor items, electronics, and/or other item categories.

In some particular examples, data segments may be based on average item sales velocity at a location in the last one month. In such examples, ML models 104a-104d may be built on data segment types, i.e. average velocity level, and not at an item class level. In some examples, one item of a particular category (for example, clothing, food/beverage, electronics, or another category) may be predicted using ML model 1 104a, while another item of the same category may be predicted by ML model 2 104b based on item velocity.

In some examples, when the machine learning application 104 is training/retraining for generation or updating of any of ML models 104a-d, the same inputs or different input factors may be utilized for training, depending on which ML model 104a-d is being generated/updated. In some examples, the input data factors may be assigned weights or priorities. The weights or priorities for a given input factor may be different based on which ML model 104a-d is being generated/updated.

In some examples, the machine learning application 104 may utilize a framework such as a Light GBM or other tree-based learning algorithm. Such a tree-based learning algorithm may have advantages over other systems, including increased speed and accuracy of generating INF prediction probabilities when training models based on realtime input data.

The predicted INF probabilities may be utilized by one or more enterprise applications within or external to the INF prediction platforms. In an example, as discussed further below, a threshold/suppression application 134 may receive generated INF probabilities for a given item-node combination. Based on that predicted INF probability, threshold/suppression application 134 may generate a threshold inventory suppression value. The threshold/suppression application 134 may be triggered to generate the threshold inventory suppression value based on a detected/received change in the realtime data received from the ATP application 106. The generated threshold inventory suppression value may be utilized by the ATP application 106 to adjust the inventory level that is shown to a user 110 (or that is utilized to determine when or how to show an item or item search result to a user 110 or to an employee searching for item inventory in one or more nodes, etc.). In another example, as discussed further below, a probability score application 136 may convert the predicted INF probability to an INF probability score. This score may be further converted by score conversion application 138 to a score format (for example, a monetary amount) that is usable by an order allocation application 118 in its analysis and determination of which order(s) to allocate to which node(s).

Databases described herein, such as enterprise database 120, may be of any appropriate database type, including distributed, centralized, relational/SQL, object-oriented, column-oriented, NoSQL, cloud-based, on-premises, operational, analytical, flat-file, network, graphical, time series, multi-model, and/or other database types. Although the databases described/shown herein are described as standalone databases for the purpose of illustrating the particular examples described, in some examples, the databases may be wholly or partially combined with other databases (including databases described relating to these examples and other enterprise databases) and may include other databases therein. Enterprise databases(s) 120 may receive and/or update stored data on a realtime basis, a periodic basis, and/or both realtime and periodic bases depending on the data type. Enterprise database(s) 120 may include inventory data 122, which may, in some examples, include data relating to inventory item quantities at node locations, planned inventory quantities at node locations, inventory re-stock data, inventory status of items (available, unavailable, out of stock, etc.), data from ATP application 106, or other inventory data. Enterprise database(s) 120 may include item data 124, which may, in some examples, include data relating to items sold/provided by the enterprise, including product identification information/a product identifier, size, features, categories, pricing, vendor/supplier, storage and/or shipping considerations, and/or other information. Enterprise database(s) 120 may include location data 126, which may, in some examples, include data relating to various locations/nodes of the enterprise, including physical locations (e.g. address, zip code, and/or coordinates), associated carriers, node type, staffing, inventory capacity and capability, and other information. Enterprise database(s) 120 may include historical INF data, which may, in some examples, historical actual INF data as reported/measured and/or historical INF predictions from INF prediction platform 102.

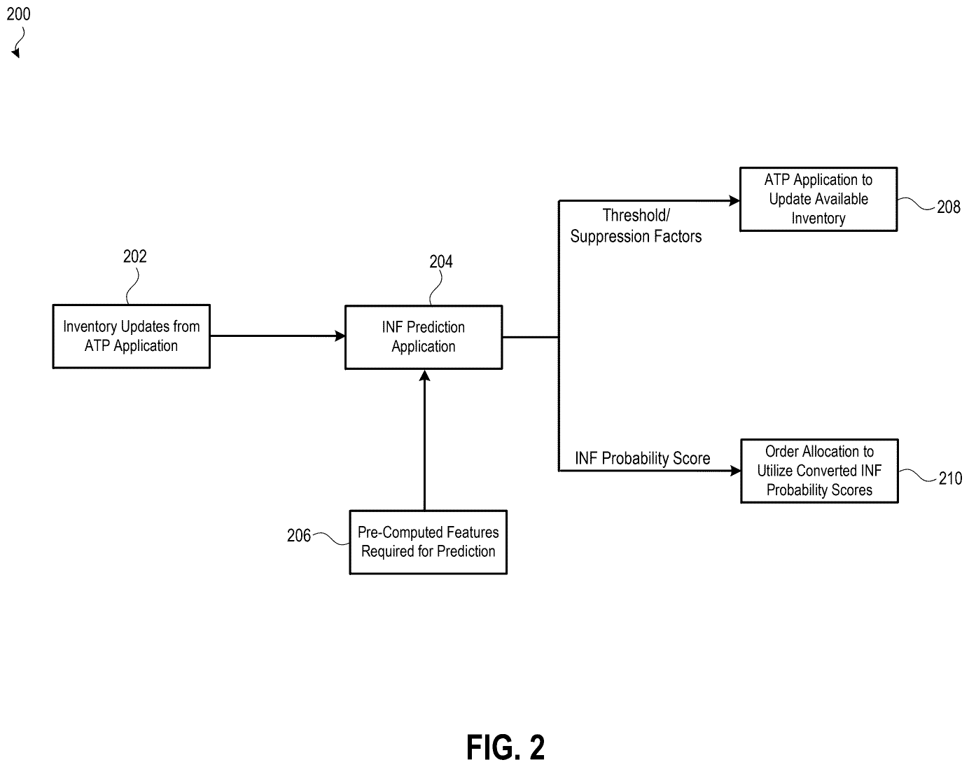

FIG. 2 illustrates an example system 200 for predicting inventory-not-found probability and for adjusting available inventories and allocation of orders. At 202, dynamic realtime inventory update data is received from an ATP application at an INF prediction application 204. This realtime data, in addition to at least pre-computed features 206 and other realtime and/or historical data from other sources, are utilized as inputs at 204 to run (or, in some examples, retrain) one or more machine learning predictive models for prediction of INF probabilities for item-node combinations. A lower predicted INF probability indicates that it is less likely that a particular item will experience an INF event at a particular node. Conversely, a higher predicted INF probability indicates that it is more likely that a particular item will experience an INF event at a particular node.

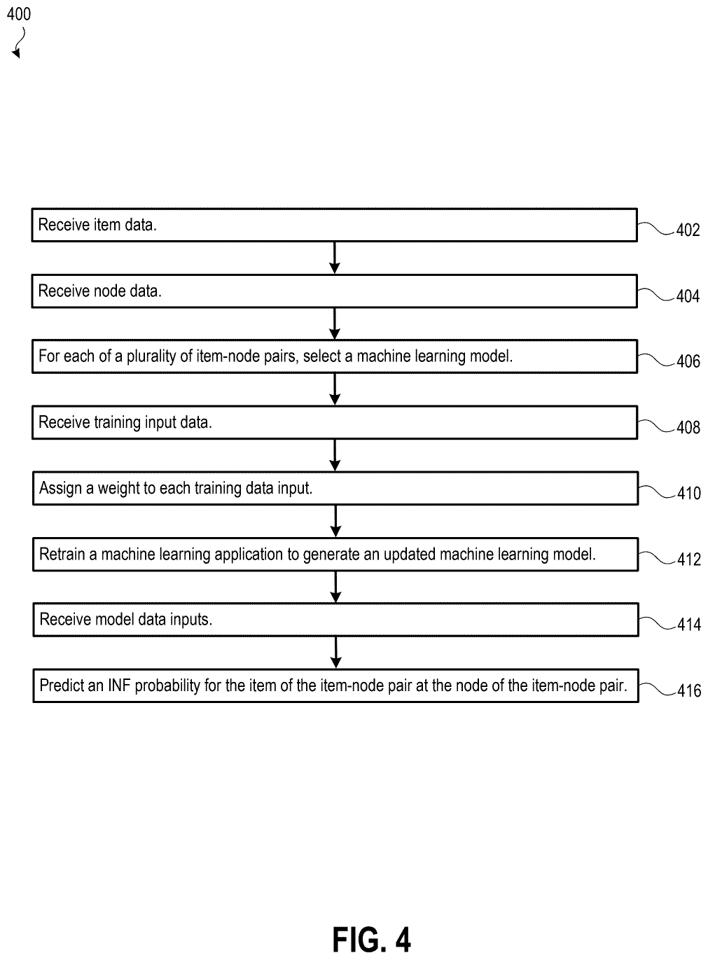

In some examples, input features/data utilized for a particular machine learning model may be determined based on a category of an item of an item-node pair and may be weighted/prioritized based on the category of the item. In some examples, weights/priorities may be based on factors such as category, seasonality, sales velocity, item features, value, model characteristic/identity, and/or other factors. In some examples, input features may include inventory attributes, such as the latest available (e.g. “on-hand”) quantity of items at a node location (for example, from an ATP application), a quantity of items required for fulfillment of an order, an average available quantity of items in a designated time period (e.g. in the last 7 days), sales forecasts, stock replenishment schedule/rate, or other factors. In some examples, input features may include item/product attributes, such as sales velocity, price, item or package weight, size, related promotions, or other factors. In some examples, input features may include past INF learnings, including historical department INF rate, node INF history data, item INF history data, and other factors. Input features are further discussed below regarding FIG. 4.

In an example, as discussed further below, based on that predicted INF probability, a threshold inventory suppression value/factor may be generated. This threshold inventory suppression value may be utilized by the ATP application at 208 to update the available inventory level that is shown to a user (or that is utilized to determine when or how to show an item or item search result to a user or to an employee).

In another example, as discussed further below, INF probability score may be generated based on the calculations from the machine learning model(s) of the INF prediction application. For example, an INF probability score of 0.3 may indicate that for a particular item-node pair, there is a 30% probability that an INF event will occur. This score may be further converted by score conversion application to a score format (for example, a monetary amount) that is usable by an order allocation application in its analysis and determination of which order(s) to allocate to which node(s). For example, an order allocation application may base its allocations of item orders to nodes on a number of intelligent rules. The consideration of the converted INF probability score may be one of the rules.

### Inventory-not-Found Prediction Model

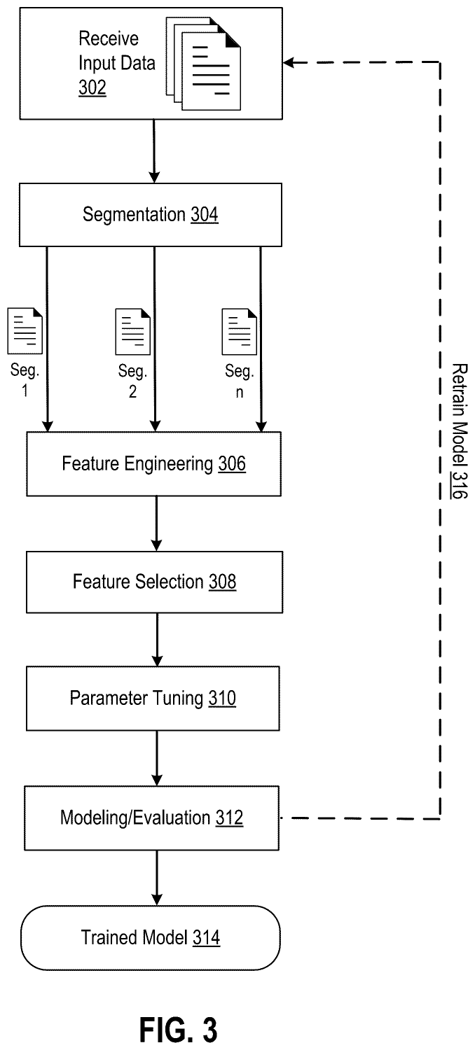

FIG. 3 illustrates example operations 300 for training an inventory-not-found probability model. The operations 300 may be carried out, for example, by a machine learning application 104 (refer also to INF prediction application 204). At operation 302, input data is received at the machine learning application. The input data may include historical data (for example, historical INF data and/or historical order fulfillment data), realtime data (for example, realtime data at the time of order placement), and/or pre-calculated data, as described herein. In some examples, input data may be defined such that, when the resulting predictive model is run, determinations may be made for any necessary item-node pair (for example, an item of an order allocated to a particular node).

At operation 304, the input data to the machine learning application is segmented in a preprocessing/segmentation stage, into a plurality of segments. In some examples, one or more predetermined business rules are utilized to perform the segmentation. In some examples, the business rules may be included in the input data. In some examples, the business rules may be received from an enterprise database such as enterprise database(s) 120.

In some examples, the following business rule according to Equation 1 may be applied for data segmentation at an item-location level, for a given item category:

$$\frac{n}{d} = average sales velocity \qquad Equation 1$$

Based on application of business rules such as Equation 1, data segments may be created. In some examples, a first data segment is created, wherein an n number units of an item is sold at a location/store(s) in a particular time period, and dequals the number of days in the particular time period. If the item has not been sold at the location for a long time, then its replenishment does not occur/is not triggered. In such a case, if an order gets assigned to this store/location, it may difficult to locate this item and can cause INF. In some examples, higher INF rates are observed in this segment, addressing class imbalance. In some examples, a second data segment is created; this second segment may contain item-location combinations such that fewer than 2 (but greater than 0) units of the item has been sold from the location/store(s) within the particular time period. This segment captures the INF patterns for most items, as in many examples, 1 unit of an item gets purchased in an example order. In some examples, a third data segment is created; this segment contains item-location combinations such that at least 2 units of the item have been sold from the location/store(s) in the particular time period. This data segment sees a large volume of data especially during events/promotions, and higher INF rate than usual, thereby addressing class imbalance.

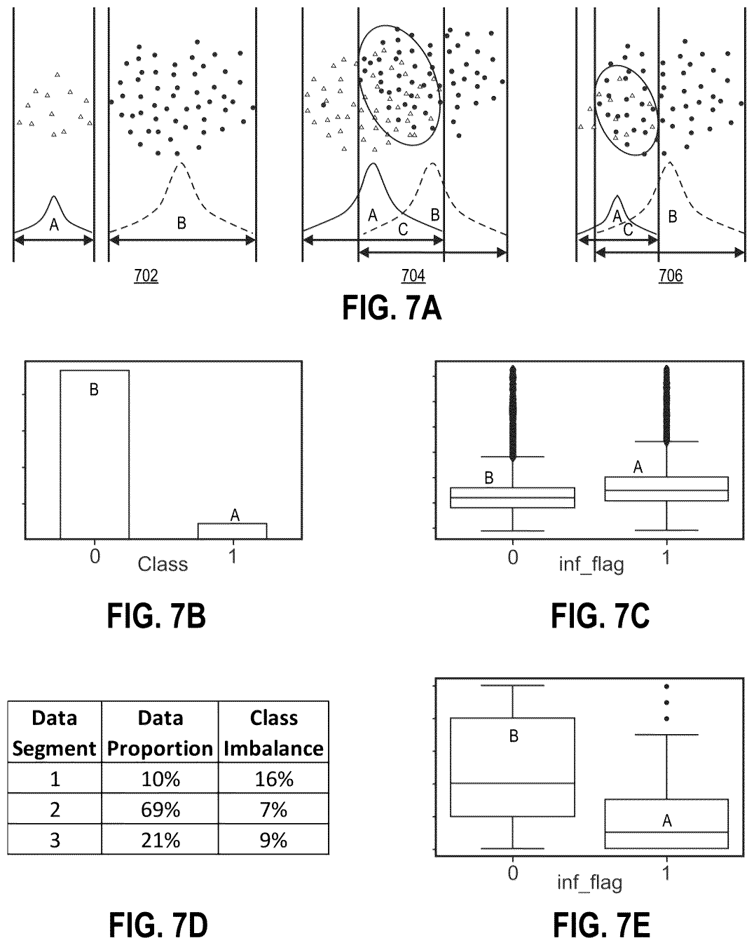

The segmentation of the data creates a plurality of distinct data segments (shown in the particular example as segments 1, 2, and n). As described briefly above, each of the generated data segments has a reduced class imbalance relative to the overall data set and less class overlap (refer also to FIGS. 7A-7E). Ensuring, at this operation, that the data segments have repeating and stable properties contributes to the accuracy and validity of the final developed predictive models. In some examples, the plurality of segments includes at least three segments, the at least three segments being selected to reduce overall class imbalance within each segment relative to class imbalance across an entirety of the historical order fulfillment data.

At operation 306, each of these segments undergoes feature engineering. Historical input data for each segment (for example, historical INF data) is analyzed, along with historical and/or realtime inventory data. Node and item attributes are also analyzed at this operation. Missing values may be identified and handled. In examples, a zero-imputation calculation is performed for the missing values, since some example features are rate features (for example, INF rates at store level, item level, department level etc.) that should have non-negative values. New features may be derived from existing features of the segmented input data. Outliers are recognized and handled, for example, via the Interquartile Range (IQR) method, which contributes to accounting for skewness and thereby reducing class overlap. A set of features is determined from the historical order fulfillment data segments.

At operation 308, a feature selection and finalization process is performed to select features that demonstrate salient differences between the classes. In some examples, open source libraries are utilized to finalize the selected set of features. In some examples, libraries/databases internal to the enterprise are utilized to finalize the selected set of features.

At operation 310, once a set of features is selected, predictive model parameters (e.g. hyperparameters) are fine-tuned to improve the output of the resulting predictive model. This generates a preliminary predictive model for predicting INF probabilities. In some examples, such tuning is performed to determine a parameters for the predictive model, given a specific set of data. In examples, a tree-based model may have parameters including depth of the tree, number of leaves, number of iterations, class balance ratio, regularization, and/or others etc. For a given training dataset, these parameter values will be different. Tuning helps to obtain near optimal values for these parameters and/or others during training/generation of the predictive model. In another example, parameters for a light GBM model may include: learning rate, number of leaves, maximum depth, feature fraction, bagging frequency, bagging fraction, minimum data in leaf, minimum sum hessian in leaf, scale/weight, number of iterations, and/or others. In another example, parameters for a CatBoost model may include: learning rate, iterations, depth, leaf reg, random strength, bagging temperature, border count, scale/weight, maximum leaves, bootstrap type, grow policy, and/or others. In some examples, the predictive model may include a tree-based model, a CatBoost model, a GBM model, regression model, neural network, graphical neural network, support vector machines model, k-nearest neighbors model, time series model, clustering model, naive bayes model, random forest model, any other type of suitable model, and/or a combination of these or other models.

At operation 312, the performance of the preliminary predictive model is evaluated. In an example, the evaluation approach may utilize of two types of data: (1) Recency, to capture recent INF patterns; and (2) Seasonality, to capture INF patterns from previous year(s) during the same time, or a same event (for example, May 2024 as compared to May 2023, or Back to School 2024 as compared to Back to School 2023). This ensures that the predictive model takes into account both recent and event-specific data. In some examples, other types of data may be utilized in the evaluation approach. In some examples, tree-based boosting classification algorithms are utilized for modeling (and therefore the resulting predictive model may be a tree-based boosting classification model). In some examples, the predictive model is validated through out-of-time validation techniques to ensure reliability on unseen data.

The operations 302-312 result in a trained predictive (machine learning) model 314 for the prediction of INF probabilities and/or events (e.g. for generating a predicted INF probability at a node). In some examples, generation of an INF prediction probability is based at least on providing (subsequent) order information to the generated predictive model. In some examples, generation of an INF prediction probability occurs further in response to providing location data to the predictive classification model, alongside the subsequent order information.

In some examples, the generated prediction of likelihood of an inventory not found event is compared against a predetermined likelihood threshold. In such an example, based on the prediction of likelihood of the inventory not found event being above the predetermined likelihood threshold, an order represented by the subsequent order information may not be allocated to a node corresponding to the location data.

In examples, the trained predictive model is one of a plurality of generated trained predictive models, each being associated with a category such as a category of items. In some examples, the model may be retrained at an operation 316, which includes repeating operations 302-312 to arrive at an updated, re-trained predictive model. Retraining of the model ensures that new historical data, updated pre-computed inputs, and new realtime data are incorporated into the training. In some examples, retraining may be performed periodically (for example, daily, monthly, yearly, or another appropriate time period). In some examples, retraining may be performed in response to a trigger event (for example, new items being entered into the enterprise inventory, the start of a season or promotion, a change in inventory processing, or other appropriate event), automatically or on an as-needed basis. In some examples, retraining is initiated automatically by one or more computing systems of the enterprise (for example, an INF prediction platform 102). In some examples, retraining may be performed when initiated by an enterprise user or trigger from an enterprise application. In some examples, retraining may be performed model in response to detected data drift.

In some examples, data drift may be analyzed, and the machine learning model may be retrained utilizing input data including new sets of recent and seasonal patterns to maintain predictive model performance. Such retraining to address data drift is important in examples where the enterprise observes or suspects the presence of noise and drift in a dataset (for example, INF occurrence or percentage, purchase/sales data, or other data). In an example, some enterprise departments or categories may have fewer purchases throughout the year, as compared to other departments or categories. These departments/categories (and/or their items, depending on the level of evaluation being performed) act as noise in the data, whose contribution to pattern learning is minimal and is overshadowed by popularly purchased items/item categories. Retraining to account for drift can also help ensure predictive model accuracy during events such as promotions, specific seasons, or holidays, during which the proportion of data from different departments/categories varies from a baseline.

FIG. 4 illustrates an example method 400 for predicting inventory-not-found probability (for example, for a plurality of item-node pairs). At operation 402, item data is received, relating to each of a plurality of items. The item data may include an item category.

At operation 404, node data is received, relating to each of a plurality of nodes (for example, nodes of a retail enterprise).

At operation 406, for each of a plurality of item-node pairs, a machine learning model is selected. Each item-node pair corresponds to a particular item of the plurality of items that is intended to be inventoried at a particular node of the plurality of nodes. In some examples, selection of the machine learning model may be performed at a machine learning application. The selection of the machine learning model may be based, at least in part, on the item category of the item of the item-node pair. The machine learning model may be selected from among a plurality of machine learning models. In examples, each of the machine learning models may have been generated as described in FIG. 3.

At operation 408, training input data is received at the machine learning application. The training input data may be based at least on the item category, and the training input data may include: historic inventory-not-found rates for one or more timeframes at the node of the item-node pair; historic inventory-not-found rates for one or more timeframes for the item of the item-node pair at the node of the item-node pair; inventory-not-found rates for a department class associated with the category of the item of the item-node pair; real-time inventory level data for the node of the item-node pair; and/or other data. In some examples, at least a first subset of the training data inputs is real-time data, wherein at least a second subset of the training data inputs is pre-computed feature data.

In some examples, the model is trained periodically. In some examples, the model is trained automatically. In some examples, the model is trained in realtime. In some examples, the model is trained based on detection or receipt of indication of a trigger event. In some examples, if a model has been trained within a specified period of time (e.g. recently), and/or the model is shown to provide outputs of a predetermined accuracy and/or confidence level, the model may not be re-trained every time it is selected for use.

In some examples, the subset of training data inputs to pre-compute is selected, and the resulting pre-computed feature data is stored in a pre-computed feature database. The pre-computed feature data may then be retrieved from the pre-computed feature database.

At operation 410, a weight is assigned to each of the training data inputs. The assigned weight may be based at least in part on the item category.

At operation 412, the machine learning application may be retrained, utilizing the weighted training data inputs. The retrained machine learning application may generate an updated version of the selected machine learning model.

At operation 414, model data inputs are received at the (updated) machine learning model. In some examples, the model data inputs may include information associated with an order for an item of an item-node pair. In some examples, the model data inputs may take the same format as the training input data; in other examples, the model data inputs may take a format different from the training data inputs.

At operation 416, at the (updated) machine learning model, an INF probability is predicted for the item of the item-node pair at the node of the item-node pair.

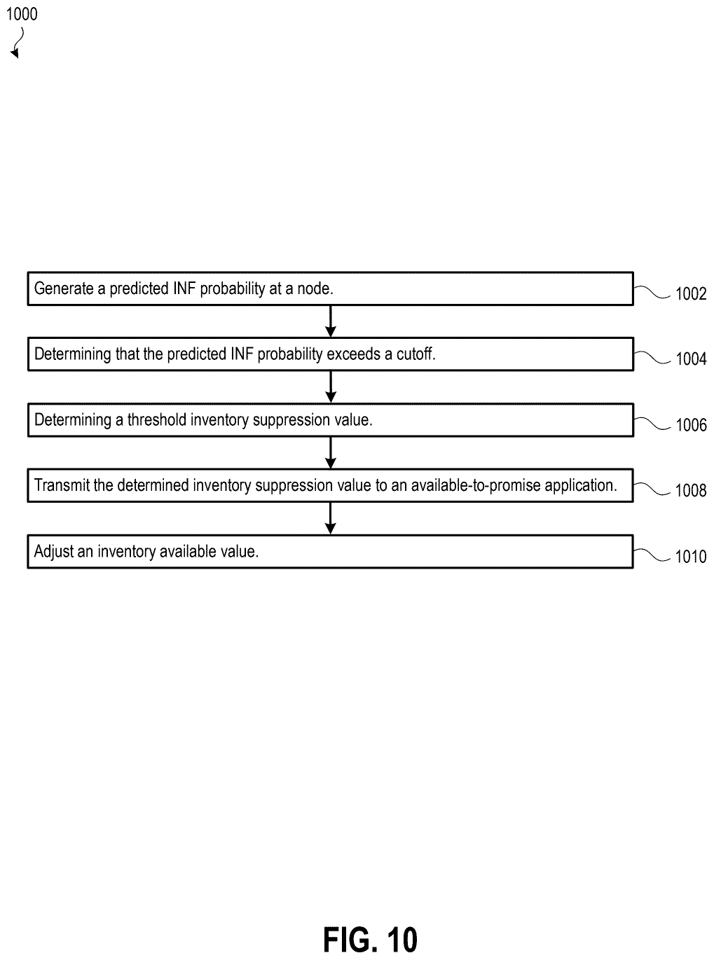

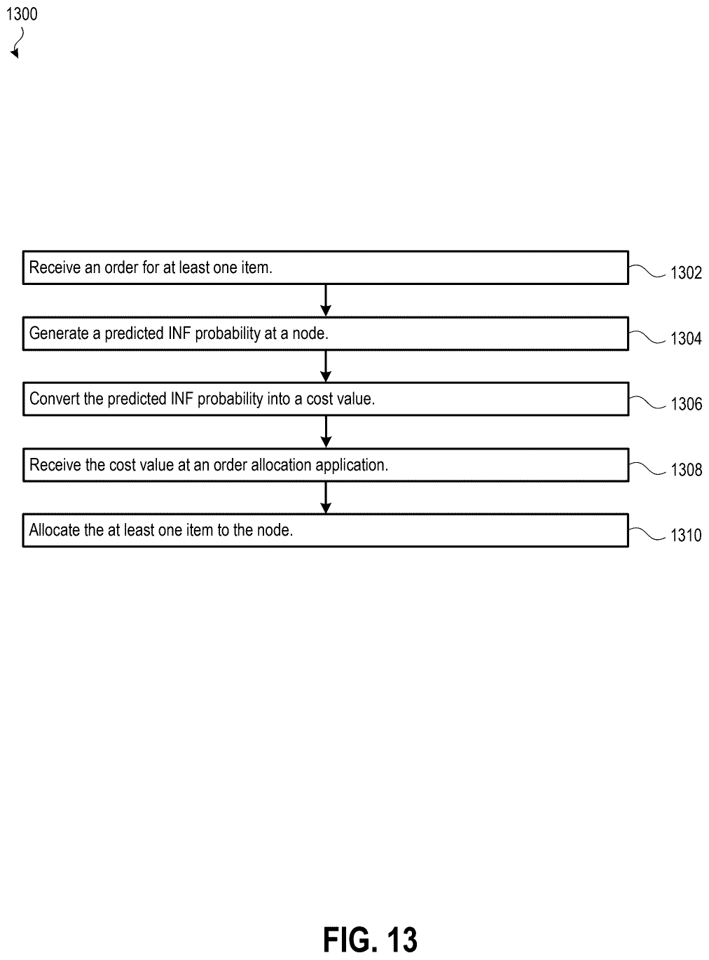

In some examples, the predicted INF probability may be further utilized, for example, in methods outlined in FIG. 10 and/or FIG. 13.

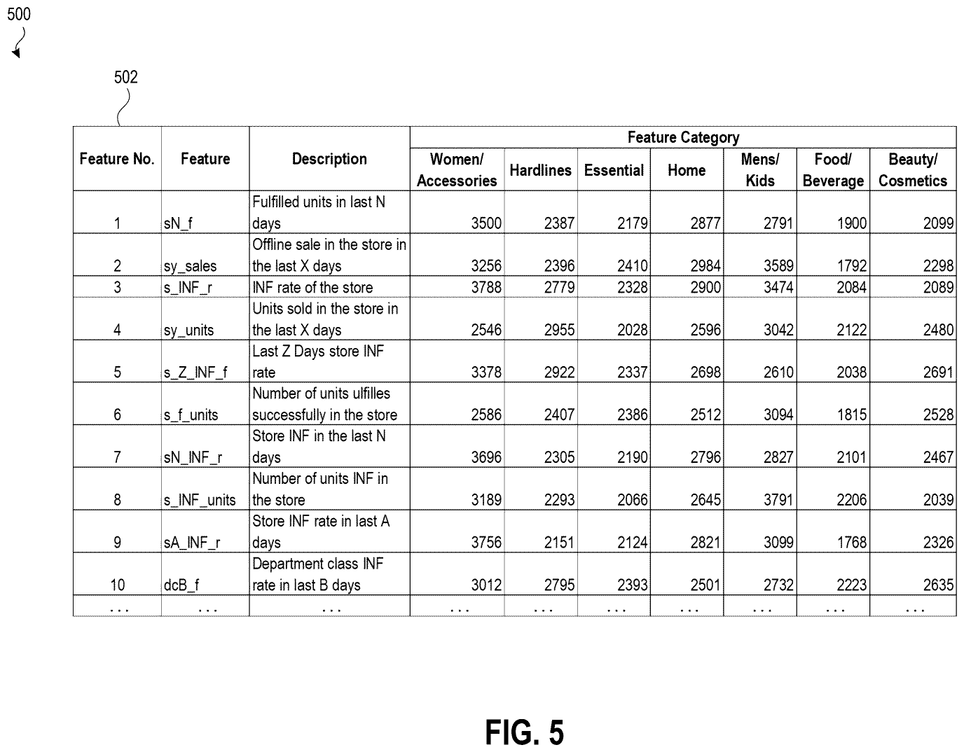

FIG. 5 illustrates a table 500 of example input data features utilized in the machine learning models (for example, for training, re-training, and/or running) of the disclosed systems and methods. In some examples, between about 80 to 100 input data features may be utilized as inputs to the machine learning models/machine learning application for training, retraining, and/or running of the models (for example, the machine learning application 104 and ML models 104a-d). In some examples, between 30 to 35 input data features may be utilized. In some examples, up to or even greater than 200 to 250 input features may be utilized. In some examples, a subset of the features is utilized for a particular machine learning model, based on the item/feature category associated with the machine learning model. In some examples, the features are assigned a weight or priority (for example, as in “feature number” column 502). In some examples, the subset of the features selected correspond to a top number of features as based on priority or weight. In some examples, a particular feature may be assigned a different priority or weight when utilized in conjunction with one machine learning model than when utilized in conjunction with another machine learning model.

In some examples, input data features may be categorized according to item category at a particular node location or at a group of node locations. In the particular example shown, features are shown in the context of a node being a store, but in other examples, the node may be a warehouse or other applicable node location as described herein. Example input data features may include a number of fulfilled units (e.g. items) in a last specified number of days, current/latest actual INF rate of a node, node actual INF rate over a time period, and/or other relevant factors.

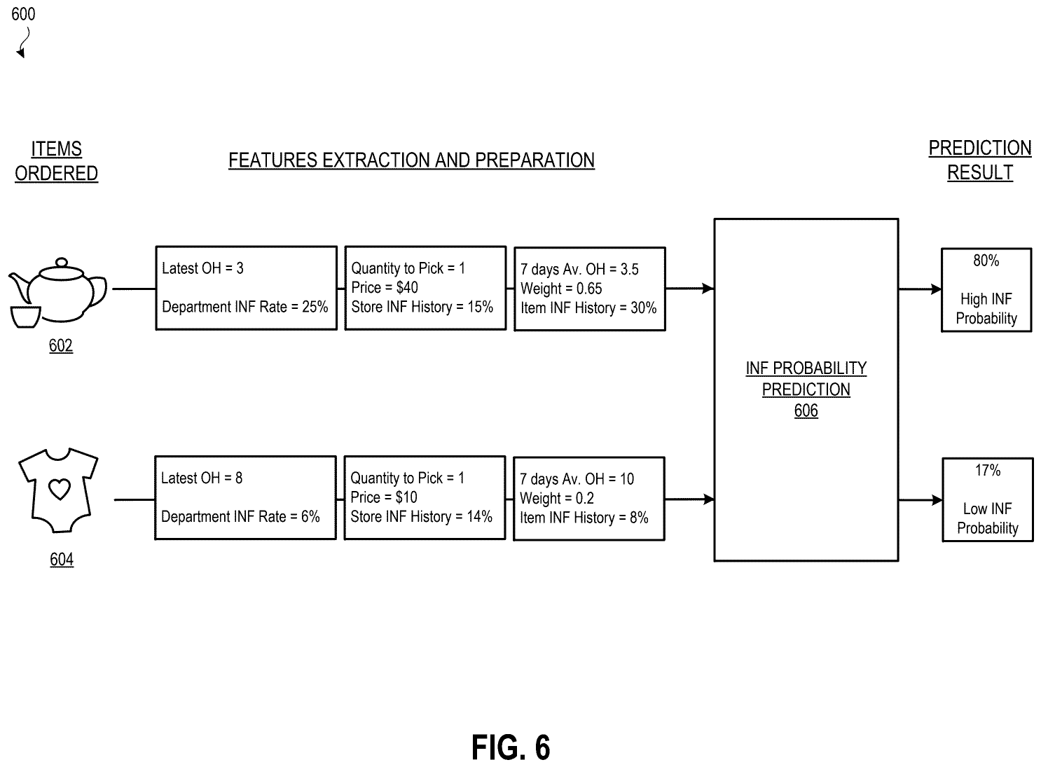

FIG. 6 illustrates example operations 600 for predicting inventory-not-found probability for selected example items. In the particular example shown, two items are ordered: a first item (a teaset) 602 of a first category (e.g. “home”) and a second item (an infant onesie) 604 of a second category (e.g. “men's/kids”). These items may be part of a singular order or multiple orders, and, in this particular example, are allocated to different nodes.

When first item is ordered and allocated, and an INF prediction platform 606 extracts features (realtime and pre-calculated input factors) related to the item-node pair. The latest on-hand (available inventory) quantity of items at the allocated node is 3 items, and the relevant department INF rate is 25%. Only one of the item was ordered in this particular order, so only one item needs to be picked. The first item costs $40, and the node/store INF history is 15%. The 7-day average on-hand quantity of items is 3.5 items, and the item INF history is 30%. These data features are ingested at the INF prediction platform 606 to train and/or run a machine learning model corresponding to the first item category, to predict an INF probability for the first item at its allocated location (for example, utilizing operations outlined in FIGS. 3-4). In this example, for the teaset at its allocated node, the INF prediction platform 606 calculates a high INF probability of 80%.

When second item is ordered and allocated, the INF prediction platform 606 extracts features (realtime and precalculated input factors) related to the item-node pair. The latest on-hand (available inventory) quantity of items at the allocated node is 8 items, and the relevant department INF rate is 6%. Only one of the item was ordered in this particular order, so only one item needs to be picked. The first item costs $10, and the node/store INF history is 14%. The 7-day average on-hand quantity of items is 10 items, and the item INF history is 8%. These data features are ingested at the INF prediction platform 606 to train and/or run a machine learning model corresponding to the second item category, to predict an INF probability for the second item at its allocated location (for example, utilizing operations outlined in FIGS. 3-4) . . . . In this example, for the teaset at its allocated node, the INF prediction platform 606 calculates a low INF probability of 17%.

FIG. 7A illustrates example class imbalance and class overlap diagrams; FIG. 7B illustrates an example percentage of samples per class, showing an among of class imbalance; FIG. 7C illustrates an example amount of class overlap. As noted above, the disclosed systems and methods for predicting INF probabilities are configured so as to address several classification difficulties.

FIG. 7A includes diagrams 702, 704, and 706, which illustrate several common classification difficulties. Diagram 702 illustrates a class imbalance, which occurs when the dataset is heavily skewed towards one class, known as the majority class B, with very few samples representing the other class, known as the minority class A. In such cases, classification algorithms (such as those used in machine learning) tend to be biased towards learning the patterns from the majority class B. FIG. 7B further illustrates class imbalance, where one class includes far more data than the other (in a particular example, where majority class B represents the non-INF class and minority class A represents the INF class).

Diagram 704 illustrates a class overlap, which occurs when instances of multiple classes A and B share a common overlapping region C in the data space/range. Data class overlap complicates classification, as it is difficult to determine a clear decision boundary between the two classes. Diagram 706 illustrates a combination of a class imbalance and class overlap in a dataset, wherein instances of a minority class A and a majority class B share a common overlapping region C in the data space. This combination can make classification additionally challenging, at least because there are fewer minority class A patterns/points available (when compared to the amount of majority class B points/patterns), and of those that exist, a number of them in overlapping region C share features/characteristics to those of majority class B. FIG. 7C further illustrates class overlap (in a particular example, where majority class B represents the non-INF class and minority class A represents the INF class), where the distributions of the features of both classes overlap significantly. This means that the range of feature values for the majority class B is substantially the same as minority class A.

As noted above, the disclosed systems and methods address these classification difficulties. Segmenting the input data into segments ensures that the data of each data segment utilized in the training of the predictive model has a reduced class imbalance relative to the overall data set and less class overlap. Feature engineering further addresses classification issues, such as reducing degree of class overlap. Evaluation and retraining of the model to account for realtime data changes, event changes, drift, and other factors further ensures that these classification difficulties are minimized. FIG. 7D illustrates an example table including class imbalance data by data segment, where the data has been segmented by an operation such as those described in FIGS. 3-4 (in a particular example, where majority class B represents the non-INF class and minority class A represents the INF class). This shows that each segment has its own discrete class imbalance datapoint, and that the class imbalance percentages are relatively low (in the particular example shown, less than 20%) for the example data segments shown, regardless of data proportion. FIG. 7E illustrates a reduced example amount of class overlap. FIG. 7E illustrates a reduced example amount of class overlap, where the segmented data has been processed at a feature engineering operation such as those described in FIG. 3-4 (in a particular example, where majority class B represents the non-INF class and minority class A represents the INF class). The resulting dataset includes a class B and class A wherein fewer datapoints exist in the overlapping region.

FIGS. 7B and 7D illustrate an example of how imbalance is beneficially reduced in segments with respects to the overall data. FIGS. 7C and 7E illustrate an example of how overlap is advantageously reduced in segments post-outlier treatment and feature engineering. The features after data segmentation are more well separated, allowing classification and/or clustering algorithms and models to find distinguishing patterns more accurately and more efficiently.

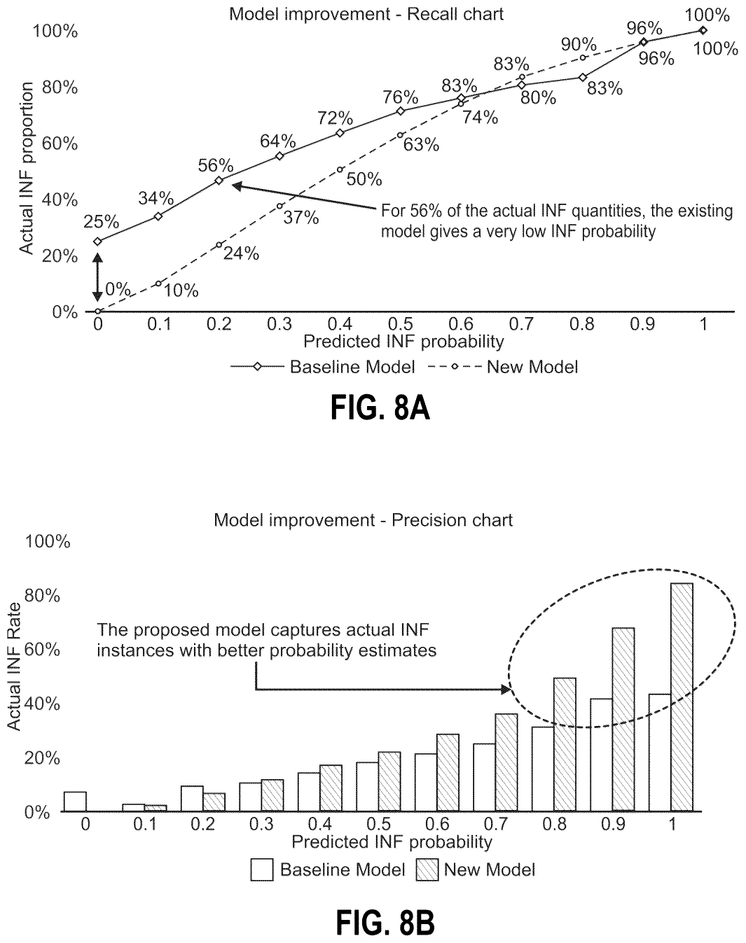

FIG. 8A illustrates an example chart depicting an improvement in recall data (for example, improvement in a recall metric). In FIG. 8A, performance of a particular example of a predictive model as disclosed (created using the data segmentation approach described above and herein), is compared to performance of a baseline model that was not created using the data segmentation approach described above. The baseline model was trained without the sales velocity segmentation described above, so it does not handle class imbalance or overlap efficiently (or at all). The comparison displays the distribution of INF occurrences based on INF probabilities generated by each different model. For example, out of 100 INF events, it may be useful to determine how many of these cases occurred when a model predicted an INF probability of less than a particular percentage. The percentage values on the chart indicate a percentage of actual INF events that occurred (out of 100, y-axis) when the model utilized predicted a particular INF probability (x-axis).

In the particular example shown, when utilizing the baseline model, 25 out of 100 actual INF events occurred when the baseline model predicted an INF probabilities less than 10%. Similarly, when utilizing the baseline model, 56 actual INF events occurred when the baseline model predicted a low probability of INF events (less than 40%). This indicates that the baseline model tends to assign low INF probabilities to most cases, and does not accurately predict (e.g. underpredicts) how many INF events will occur. Consequently, when utilizing the baseline, items or orders that should be classified as having a high probability of having an INF event are instead predicted as having a low probability of having an INF event, resulting in an increase in False Negatives. As the number of False Negatives increases, the recall performance deteriorates.

In contrast, the predictive model generated using the methods and systems outlined herein produces significantly fewer False Negatives, thereby enhancing the overall recall. The predictive model more closely predicts INF event probability, especially for lower INF percentages, in the particular example shown.

FIG. 8B illustrates an example chart depicting an improvement in precision of INF prediction precision. The chart provided showcases a comparison between the INF rate at various INF probabilities produced by each of the models discussed in reference to FIG. 8A.

In the particular example shown, 100 INF events are forecasted to have a 90% probability of an INF event. That is, out of 100 cases that are predicted to have an INF rate of 90% (i.e. 90% are predicted to be INF events), the baseline model captures only 42 of these cases accurately (that is, only 42 cases actually turn out to be an INF events). In comparison, the predictive model as disclosed herein captures 68 of the INF events accurately. Consequently, the new predictive model yields a higher number of True Positives, which enhances the overall prediction precision.

FIGS. 8A and 8B illustrate an example of how the disclosed segmentation helps to improve both recall and precision. That is, with the segmentation approach, the model advantageously more confidently predicts both INF and non-INF cases with higher accuracy.

### Updating Available Inventory

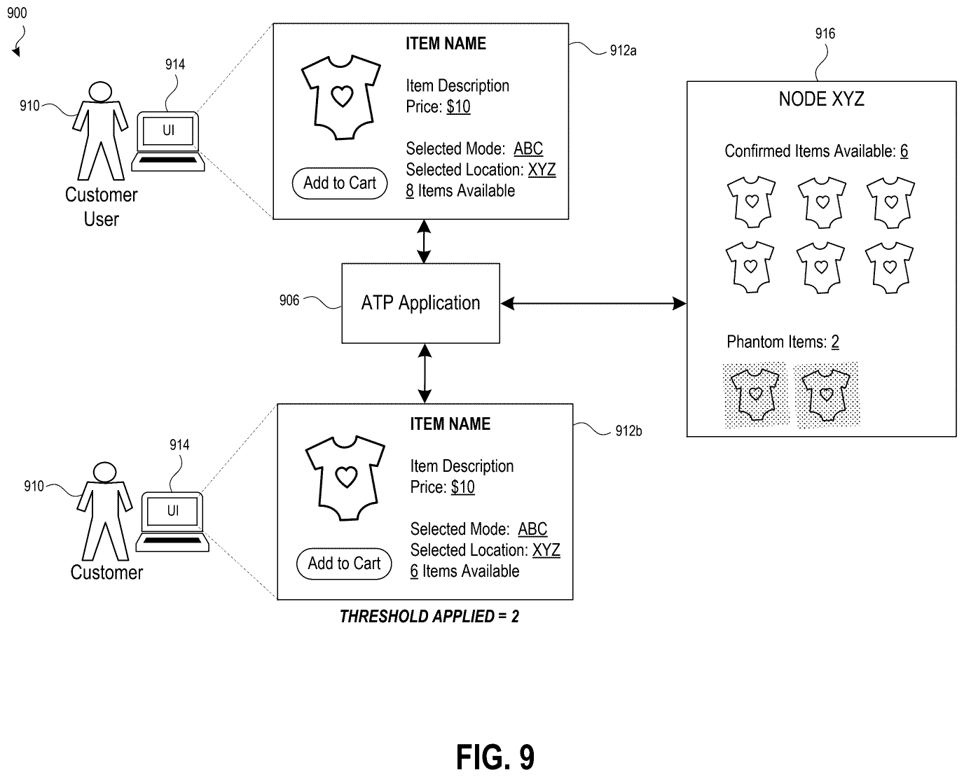

FIG. 9 illustrates an example user interface depicting an inventory availability before and after a threshold adjustment. In the particular example shown, a customer user 910 interacts with a user interface 912a on a device 914. User 910, user interface 912a (and 912b), and device 914 may have the characteristics of user 110, user interface 112, and device 114. User interface 912a may display information associated with an item to user 910, including a picture of the item, item name, item description, item price, selected mode of acquisition (e.g. ship-to-home, same day delivery, store pickup, or others), a selected location (e.g. a node or destination), an add-to-cart feature, and/or a number of items available. In the particular example shown, user interface indicates to user 910 that there are 8 of the item available for purchase.

The number of available items is provided to the user interface 912a by an ATP application 906 (for example, ATP application 106). If user 910 orders the item, the order will be allocated to a node XYZ 916 by an order allocation application. In this particular example, inventory data (such as that provided by ATP application 906) indicates that node 916 has 8 of the item available, but only 6 items can be confirmed to be available at node 916. This leaves 2 phantom items at node 906. This means that if 8 items are ordered/purchased by one or more customer users 910, then 2 INF events may occur.

In some examples, if there is risk of INF at a requested quantity 7 or higher, a threshold order limit may be applied such that the requested quantity cannot be placed, leading to a threshold of 2 (for example, a customer 910 may be prevented from ordering 7 or more of the particular item).

The relevant item and node information may be received at an INF prediction platform as described herein, and a relevant machine learning model will generate predicted INF probabilities for the item-node 916 pair based at least in part on realtime data. The INF prediction platform may generate a threshold inventory suppression value based on inventory data and/or the predicted INF probabilities, as discussed above regarding FIG. 2 and below regarding FIGS. 7 and 8. In the particular example, the generated threshold inventory suppression value is equal to 2.

ATP application 906 applies the threshold inventory suppression value to the number of items available that is presented on the user interface 912b. The example user interface 912b indicates that 6 of the item are available for purchase. Suppressing the available inventories as presented to users in this manner reduces the likelihood of an INF event for the item at the node 916.

FIG. 10 illustrates an example method 1000 for adjusting an available inventory level. At operation 1002, a predicted INF probability for an item at a node is generated. In some examples, the predicted INF probability is generated by a machine learning model as described in relation to the process 300 of FIG. 3. In some examples, the predicted INF probability is generated by an updated machine learning model as described in relation to the method 400 of FIG. 4.

At operation 1004, it is determined that the predicted INF probability exceeds a cutoff/threshold INF probability. In some examples, the cutoff INF probability is based on the item category. In some examples, the cutoff INF probability is based at least in part on a selected item delivery method. In some examples, the cutoff INF probability is based off of a requested item quantity/count level.

In some examples, prior to determining that the predicted inventory-not-found probability exceeds the cutoff INF probability, an indication is received of a change event at an available-to-promise application. Based on the change event, the determination that the predicted inventory-not-found probability exceeds the cutoff inventory-not-found probability may be initiated.

At operation 1006, a threshold inventory suppression value is determined, that is less than a predetermined threshold inventory suppression cap.

At operation 1008, the determined threshold inventory suppression value is transmitted to an available-to-promise application. At operation 1010, at the available-to-promise application, an inventory available value is adjusted based on the determined threshold inventory suppression value. The adjustment may cause the adjusted inventory available value to be displayed on a user interface of a customer.

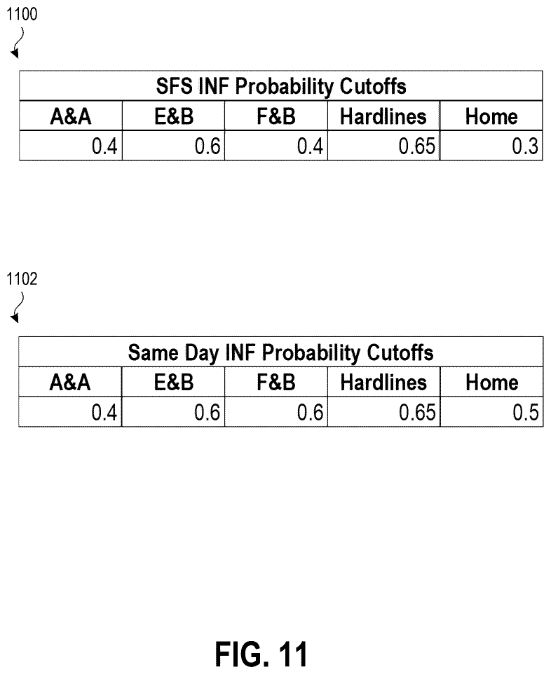

FIG. 11 illustrates example inventory-not-found probability cutoff values for use in the disclosed systems and methods. In some examples, threshold INF probability cutoffs may differ based on item category and/or ship/acquisition method. In the example shown, table 1100 depicts example cutoff values for five example item categories, all when the ship method is ship-from-store. Although the ship method is the same, the cutoff values for some of the item categories vary. Also in the example shown, table 1102 depicts example cutoff values for the same five item categories, all when the ship method is same-day delivery. Again, although the ship method is the same, the cutoff values for some of the item categories vary. Further, this illustrates that cutoff values may vary for the same item category based on ship method. For example, the item category “home” has an INF probability cutoff of 0.3 when an item of the category is designated for ship-from-store delivery, but has an INF probability cutoff of 0.5 when an item of the category is designated for same day delivery. In some examples, some item types and categories may better withstand INF, so, higher cutoffs may be utilized to increase availability of the associated items and to reduce suppression.

### Order Allocation

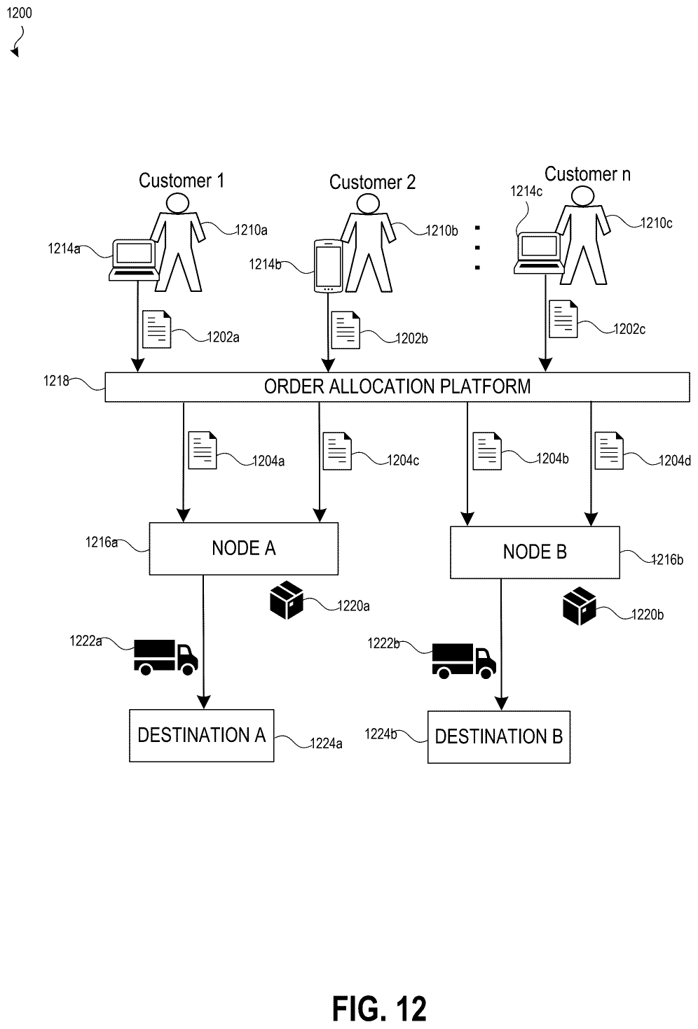

FIG. 12 illustrates a depiction 1200 of online orders being allocated to a particular node for fulfillment. A customer user 1210 (for example, user 110) may place one or more virtual orders 1202 from an enterprise that are to be shipped to a destination 1224. Each placed virtual order 1202 may include one or more items/products. Virtual orders may be placed by the customer users 1210 via devices 1214, which may be a device as described herein with relation to device 114. In some examples, a customer 1 1210a may place a virtual order 1202a via a device 1214a. In some examples, a customer 2 1210b may place a virtual order 1202b via a device 1214b. In some examples, a customer n 1210c may place a virtual order 1202c via a device 1214c; virtual order 1202c may include multiple items/products that are to be delivered to a single destination.

Virtual orders 1202 may be received at an order allocation application 1218 of the enterprise (for example, order allocation application 118). Order allocation application 1218 allocates each of the virtual orders 1202 and their associated items/products to one or more nodes 1216 (e.g. warehouses, fulfillment centers, consolidation centers, stores, producers, factories, or other node types) for processing/fulfillment. Order allocation application 1218 may utilize information such as node capacity, carrier capacity, order/item priority, delivery deadline, item/product stock levels, and other data in order to allocate the orders 1202. In some examples, a virtual order 1202a may include a single item/product, and may be allocated in its entirety as order 1204a to node A 1216a. In some examples, a virtual order 1202b may include multiple items/products, and may be allocated in its entirety as order 1204b to node B 1216b. In some examples, a virtual order 1202c may include multiple items/products, and may be allocated to two separate nodes, where one or more of the items/products are allocated as order 1204c to node A 1216a and the remaining one or more items/products are allocated as order 1204d to node B 1216b.

In some examples, allocated orders 1204 may then released to the nodes 1216 so that the items may be fulfilled. For example, the associated items/products may be picked from their shelved/stocked inventory locations and packed into one or more packages 1220 (for example, boxes, bags, envelopes, or other packaging). The physical packages may be received/picked up by a carrier vehicle (for example, trucks, vans, other road vehicles, air freight, barges, freighters, cargo vessels, or other shipping methods associated with a delivery service or last-mile delivery service) 1222, for transport to a destination 924 associated with the initial virtual order 1202 and/or the customer user 1210. Destinations A 1224a and/or destination B 924b may be a home, business, store, post office box, or other destination. In some examples, a package 1220a may be designated for a shipping carrier vehicle 1222a. In some examples, a package 1220b may be designated for a customer 1210 to pick up the item at the node B 1216b location.

While the items are being picked for order fulfillment, if the item (or an adequate quantity of items) cannot be found, then an INF event occurs and the order cannot be fulfilled as originally allocated. The customer 1210 may be notified, and the item may be sourced and/or shipped from another node (which may be a more costly option and may mean a delayed delivery to the customer), or the order may be cancelled and the customer 1210 refunded (which leads to a loss of revenue for the enterprise).

FIG. 13 illustrates an example method 1300 for allocation of orders for fulfillment that takes into consideration a predicted INF probability. At operation 1302, an order for at least one item may be received from a customer. The at least one item may correspond to an item-node pair.

At operation 1304, a predicted INF probability for an item at a node is generated. In some examples, the predicted INF probability is generated by a machine learning model as described in relation to the process 300 of FIG. 3. In some examples, the predicted INF probability is generated by an updated machine learning model as described in relation to the method 400 of FIG. 4.

At operation 1306, the predicted INF probability is converted into a cost value. At operation 1308, the cost value is received at an order allocation application. At operation 1310, the ordered at least one item is allocated to the node associated with the item-node pair, based at least in part on the cost value.

In some examples, the order may include a first item and a second item. In such examples, the method 1300 may further include operations wherein a first cost value corresponding to a first node and to the first and second items is received. A second cost value corresponding to a second node and to the first and second items may also be received. It may then be determined which of the first cost value and the second cost value is lower in value. Both the first and second items may be allocated to the node associated with the cost value determined to be lower in value.

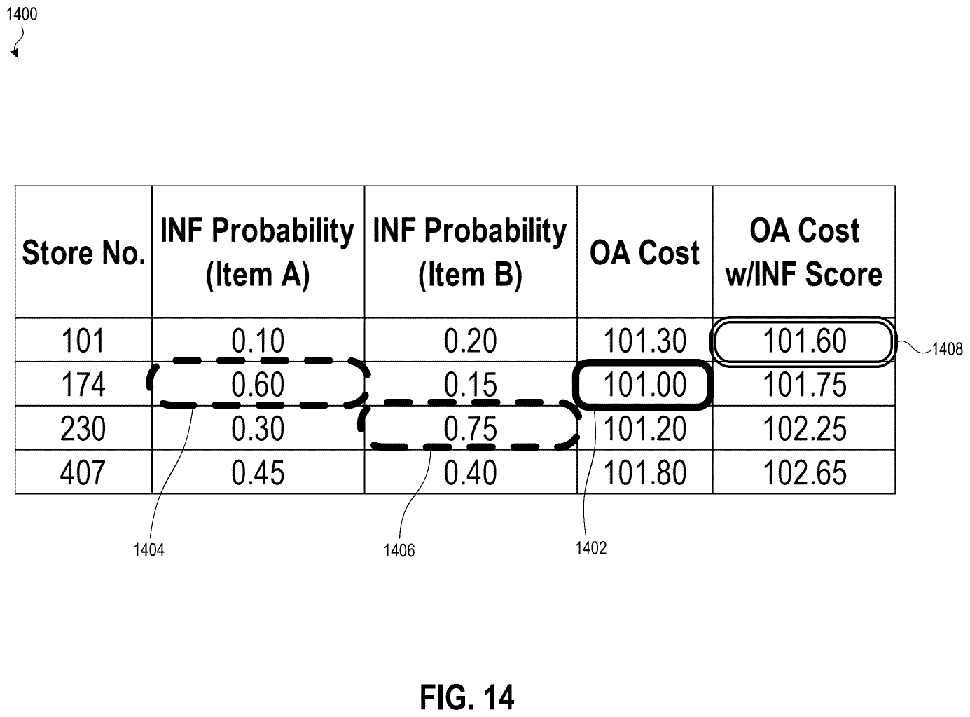

FIG. 14 illustrates example predicted inventory-not-found probability data and order allocation system costs for an order including multiple items. In the particular example shown, table 1400 depicts example predicted inventory-not-found probabilities and associated order allocation system costs at four different nodes. In the particular example shown, the data in table 1400 is shown in the context of a node being a store, but in other examples, the node may be a warehouse or other applicable node location as described herein. As shown in table 1400, an order has been placed that includes an Item A and an Item B. An order allocation application will determine whether to allocate Items A and B to Store 101, 174, 230, or 407, which all are indicated to have both Items A and B in stock. As part of its allocation analysis and application of rules, the order allocation application assigns an allocation cost to each store for fulfillment of Items A and B at that node location, and the store with the lowest assigned cost is selected. This cost may be measured in a currency amount (for example, US dollars), another unit of measure, or may be a unitless score.

Without considering predicted INF probabilities, the order allocation application assigns an allocation cost to each store considered. In the example shown, the lowest assigned cost 1402 is 101.00, assigned to Store 174.

However, in this example, when INF probabilities are considered, the lowest assigned cost 1408 is assigned to a different store, altering the allocation decision. In this example, at Store 101, both Items A and B may have a low predicted INF probability. In this example, at Store 407, both Items A and B may have a relatively higher predicted INF probability that remains below a threshold or cutoff value. In this example, at Stores 174 and 230, one of or both Items A and B may have a higher predicted INF probability 1404, 1406 that is greater than a threshold or cutoff value.

In the example shown, a predicted INF probability for Item A at Store 101 is 0.1, and for Item B is 0.2. These probabilities correlate to (e.g. are converted by a score conversion application) an INF score of 0.3, so the assigned allocation cost when considering INF probabilities is 101.60. This is higher than the assigned allocation cost for Store 101 when INF was not considered (101.30). When the predicted INF probabilities are similarly converted to assigned allocation costs and considered for the remaining stores, the lowest assigned cost 1408 is assigned to Store 101.

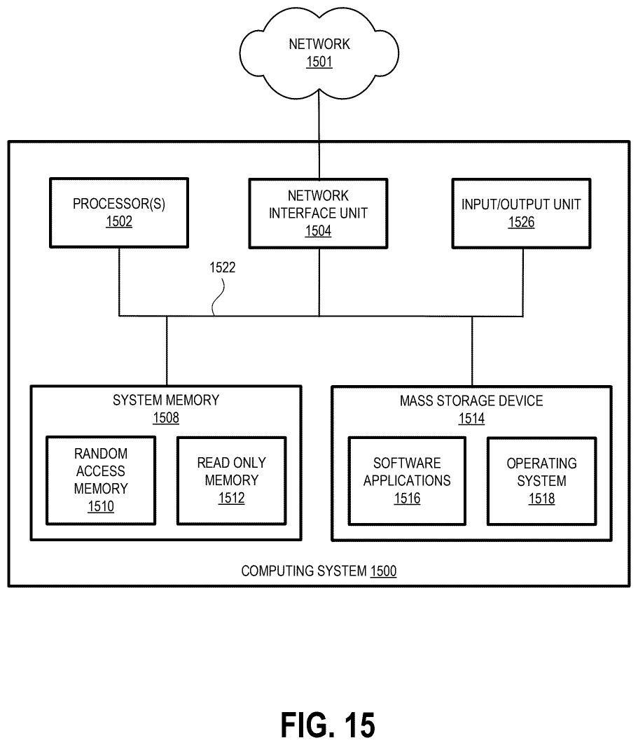

FIG. 15 illustrates an example block diagram of a virtual or physical computing system 1500. One or more aspects of the computing system 1500 can be used to implement the systems described herein, store instructions described herein, and preform operations described herein.

In the embodiment shown, the computing system 1500 includes one or more processors 1502, a system memory 1508, and a system bus 1522 that couples the system memory 1508 to the one or more processors 1502. The system memory 1508 includes RAM (Random Access Memory) 1510 and ROM (Read-Only Memory) 1512. A basic input/output system that contains the basic routines that help to transfer information between elements within the computing system 1500, such as during startup, is stored in the ROM 1512. The computing system 1500 further includes a mass storage device 1514. The mass storage device 1514 is able to store software instructions and data. The one or more processors 1502 can be one or more central processing units or other processors.

The mass storage device 1514 is connected to the one or more processors 1502 through a mass storage controller (not shown) connected to the system bus 1522. The mass storage device 1514 and its associated computer-readable data storage media provide non-volatile, non-transitory storage for the computing system 1500. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROM s, DVD (Digital Versatile Discs), other optical storage media, magnetic cassettes, magnetic tape, magnetic disk storage or other magnetic storage devices, or any other medium which can be used to store the desired information and which can be accessed by the computing system 1500.

According to various embodiments of the invention, the computing system 1500 may operate in a networked environment using logical connections to remote network devices through the network 1501. The network 1501 is a computer network, such as an enterprise intranet and/or the Internet. The network 1501 can include a LAN, a Wide Area Network (WAN), the Internet, wireless transmission mediums, wired transmission mediums, other networks, and combinations thereof. The computing system 1500 may connect to the network 1501 through a network interface unit 1504 connected to the system bus 1522. It should be appreciated that the network interface unit 1504 may also be utilized to connect to other types of networks and remote computing systems. The computing system 1500 also includes an input/output controller 1506 for receiving and processing input from a number of other devices, including a touch user interface display screen, or another type of input device. Similarly, the input/output controller 1506 may provide output to a touch user interface display screen or other type of output device.

As mentioned briefly above, the mass storage device 1514 and the RAM 1510 of the computing system 1500 can store software instructions and data. The software instructions include an operating system 1518 suitable for controlling the operation of the computing system 1500. The mass storage device 1514 and/or the RAM 1510 also store software instructions, that when executed by the one or more processors 1502, cause one or more of the systems, devices, or components described herein to provide functionality described herein. For example, the mass storage device 1514 and/or the RAM 1510 can store software instructions that, when executed by the one or more processors 1502, cause the computing system 1500 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures, systems, and methods shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computing system, comprising:
at least one processor; and
at least one memory storing computer-executable instructions for generating inventory-not found probability predictions for a plurality of item-node pairs, the computer-executable instructions when executed by the at least one processor causing the computer to:
receive item data relating to each of a plurality of items, wherein the item data comprises an item category;
receive node data relating to each of a plurality of nodes;
for each item-node pair, wherein an item-node pair corresponds to a particular item of the plurality of items that is intended to be inventoried at a particular node of the plurality of nodes:
select, based at least on the item category of the item of the item-node pair, at a machine learning application, a machine learning model of a plurality of machine learning models to update;
receive, at the machine learning application, training input data, the training input data received being based at least on the item category, the training data input comprising:
historic inventory-not-found rates for one or more timeframes at the node of the item-node pair;
historic inventory-not-found rates for one or more timeframes for the item of the item-node pair at the node of the item-node pair;
inventory-not-found rates for a department class associated with the category of the item of the item-node pair; and
real-time inventory level data for the node of the item-node pair;
wherein at least a first subset of the training data inputs is real-time data, wherein at least a second subset of the training data inputs is pre-computed feature data;
based on the item category, assigning a weight to each of the training data inputs;
using the weighted training data inputs, re-train the machine learning application to generate an updated version of the selected machine learning model;
receive model data inputs at the updated machine learning model; and
predict, at the updated machine learning model, an inventory-not-found probability for the item of the item-node pair at the node of the item-node pair.

2. The computing system of claim 1, further comprising instructions to:
select the subset of training data inputs to pre-compute;
store the resulting pre-computed feature data in a pre-computed feature database; and
retrieve the pre-computed feature data from the pre-computed feature database.

3. The computing system of claim 1, further comprising instructions to:
receive, at the machine learning application, historical order fulfillment data associated with a plurality of item-node pairs, the historical order fulfillment data comprising historical inventory not found data, historical inventory data, store attribute data, and item attribute data;
segmenting the historical order fulfillment data into a plurality of segments;
determining a set of features from the historical order fulfillment data;
performing a feature selection process to select features in each of a plurality of classes of item data, the selected features being indicative of differences between the plurality of classes;
fine-tuning hyperparameters utilized to configure a predictive classification model; and
save the predictive classification model as one of the plurality of machine learning models.

4. The method of claim 3, wherein the plurality of segments includes at least three segments, the at least three segments being selected to reduce overall class imbalance within each segment relative to class imbalance across an entirety of the historical order fulfillment data.

5. The computing system of claim 1, further comprising instructions to:
determine that the predicted inventory-not-found probability exceeds a cutoff inventory-not-found probability, the cutoff inventory-not-found probability being based on the item category;
determine a threshold inventory suppression value that is less than a predetermined threshold inventory suppression cap;
transmit the determined threshold inventory suppression value to an available-to-promise application; and
at the available-to-promise application, adjust an inventory available value based on the determined threshold inventory suppression value, causing the adjusted inventory available value to be displayed on a user interface of a customer.

6. The computing system of claim 4, wherein the cutoff inventory-not-found probability is based at least in part on a selected item delivery method.

7. The computing system of claim 1, further comprising instructions to:
convert the predicted inventory-not-found probability into a cost value;
receive, at an order allocation application, the cost value;
receive an order for at least one item from a customer, the at least one item corresponding to the item of the item-node pair; and
based at least in part on the cost value, allocate the ordered one or more items to the node of the item-node pair.

8. The computing system of claim 6, wherein the order comprises a first item and a second item, further comprising instructions to:
receive a first cost value corresponding to a first node and to the first and second items;
receive a second cost value corresponding to a second node and to the first and second items;
determine which of the first cost value and the second cost value is lower in value; and
allocate both the first and second items to the cost value determined to be lower in value.

9. A method, comprising:
receiving historical order fulfillment data associated with a retail enterprise, the historical order fulfillment data including historical inventory not found data, historical inventory data, store attribute data, and item attribute data;
segmenting the historical order fulfillment data into a plurality of segments;
determining a set of features from the historical order fulfillment data;
performing a feature selection process to select features in each of a plurality of classes of item data, the selected features being indicative of differences between the plurality of classes;
fine-tuning hyperparameters utilized to configure a predictive classification model;
based on providing subsequent order information to the predictive classification model, generating a generating a predicted inventory-not-found probability at a node associated with the retail enterprise;
determining that the predicted inventory-not-found probability exceeds a cutoff inventory-not-found probability;
determining a threshold inventory suppression value that is less than a predetermined threshold inventory suppression cap;
transmitting the determined threshold inventory suppression value to an available-to-promise application; and
at the available-to-promise application, adjusting an inventory available value based on the determined threshold inventory suppression value, causing the adjusted inventory available value to be displayed on a user interface of a customer.

10. The method of claim 9, wherein the cutoff inventory-not-found probability being based on the item category.

11. The method of claim 9, wherein the cutoff inventory-not-found probability is based at least in part on a selected item delivery method.

12. The method of claim 9, further comprising:
prior to determining that the predicted inventory-not-found probability exceeds the cutoff inventory-not-found probability, receiving an indication of a change event at the available-to-promise application; and
based on the change event, initiating the determination that the predicted inventory-not-found probability exceeds the cutoff inventory-not-found probability.

13. A method, comprising:
receiving historical order fulfillment data associated with a retail enterprise, the retail enterprise comprising one or more nodes, the historical order fulfillment data including historical inventory-not-found data, historical inventory data, store attribute data, and item attribute data;
segmenting the historical order fulfillment data into a plurality of segments;
determining a set of features from the historical order fulfillment data;
performing a feature selection process to select features in each of a plurality of classes of item data, the selected features being indicative of differences between the plurality of classes;
fine-tuning hyperparameters utilized to configure a predictive classification model;
receiving an order for at least one item from a customer, the at least one item corresponding to an item-node pair;
based on providing order information associated with the received order to the predictive classification model, generating a predicted inventory-not-found probability at a node of the one or more nodes that is associated with the item-node pair;
converting the predicted inventory-not-found probability into a cost value;
receiving, at an order allocation application, the cost value; and
based at least in part on the cost value, allocating the ordered one or more items to the node associated with the item-node pair.

14. The method of claim 13, wherein the order comprises a first item and a second item, further comprising:
receiving a first cost value corresponding to a first node and to the first and second items;
receiving a second cost value corresponding to a second node and to the first and second items;
determining which of the first cost value and the second cost value is lower in value; and
allocate both the first and second items to the node corresponding to the cost value determined to be lower in value.

15. A method of predicting an inventory not found event occurring in a retail enterprise in response to receipt of a digital order, the method comprising:
receiving historical order fulfillment data associated with the retail enterprise, the historical order fulfillment data including historical inventory not found data, historical inventory data, store attribute data, and item attribute data;
segmenting the historical order fulfillment data into a plurality of segments;
determining a set of features from the historical order fulfillment data;
performing a feature selection process to select features in each of a plurality of classes of item data, the selected features being indicative of differences between the plurality of classes;
fine-tuning hyperparameters utilized to configure a predictive classification model; and
based on providing subsequent order information to the predictive classification model, generating a prediction of likelihood of an inventory not found event at a node associated with the retail enterprise.

16. The method of claim 15, wherein the plurality of segments includes at least three segments, the at least three segments being selected to reduce overall class imbalance within each segment relative to class imbalance across an entirety of the historical order fulfillment data.

17. The method of claim 15, wherein the prediction of likelihood of an inventory not found event occurs further in response to providing location data to the predictive classification model alongside the subsequent order information.

18. The method of claim 17, wherein the prediction of likelihood of an inventory not found event is compared against a predetermined likelihood threshold.

19. The method of claim 18, further comprising, based on the prediction of likelihood of the inventory not found event being above the predetermined likelihood threshold, avoiding allocating an order represented by the subsequent order information to a node corresponding to the location data.

20. The method of claim 15, wherein segmenting the historical order fulfillment data into the plurality of segments is performed based on a set of predefined business rules.

21. The method of claim 15, wherein the historical order fulfillment data includes recency data to capture recent inventory-not-found patterns, and seasonality data to capture historical inventory-not-found patterns from an equivalent period in the previous year.

22. The method of claim 15, wherein the machine learning model is validated through out-of-time validation to ensure reliability on unseen data.

23. The method of claim 15, further comprising retraining the model in response to detected data drift.
